(19) United States
(12) Patent Application Publication
(10) Pub. No.: US 2012/0038071 A1
(43) Pub. Date: Feb. 16, 2012

(54) OPTICAL IMPRINTING METHOD AND DEVICE

(75) Inventors: Naoaki YAMASHITA, Kamisato (JP); Shinjiro ISHII, Kamisato (JP); Masashi AOKI, Kamisato (JP); Noritake SHIZAWA, Kamisato (JP)

(73) Assignee: HITACHI HIGH-TECHNOLOGIES CORPORATION, Tokyo (JP)

(21) Appl. No.: 13/208,627

(22) Filed: Aug. 12, 2011

(30) Foreign Application Priority Data
Aug. 12, 2010 (JP) 2010-180750

(51) Int. Cl. G02B 1/12; B29C 35/08

(52) U.S. Cl. 264/1.38; 425/174.4

(57) ABSTRACT

In an optical imprinting method, after pressing a mold with a mold pressing mechanism detachably holding a mold against a resist applied to a transferred body to firmly attach the mold to the transferred body and detaching the mold from the mold pressing mechanism, arranging a UV light source above the up side surface of the laminated body of the mold and irradiating UV light to cure the resist. Then, after completing the resist curing, retracting the mold and the transferred body from the UV light source and separating the mold from the transferred body.

### BACKGROUND OF THE INVENTION

The present invention relates to an optical imprinting method and device, and more specifically to an optical imprinting exposure method that hardly causes a fine pattern forming defect and exposure unevenness and to an optical imprinting device used for carrying out this method.

Due to remarkable functional improvement of various types of information devices such as a computer, an amount of information handled by a user continuously increases, reaching from a giga-unit area to a tera-unit area. Under such an environment, there have been increasing demands for semiconductor devices (such as information recording and reproducing devices and memories) with even higher recording density.

Increasing the recording density requires an even finer processing technology. A conventional optical lithography method using exposure processing is capable of fine processing of a large area at one time, but is not suitable for fabricating a fine structure having a wavelength of light or less (for example, 100 nm or less) by itself since this method does not have resolution for the wavelength of light or less. Processing technologies for the fine structure having the wavelength of light or less include: an exposure technology using an electron beam; an exposure technology using X rays; an exposure technology using ion rays; etc. However, pattern formation with an electron beam lithography device, unlike pattern formation by one-shot exposure method using a light source such as i rays, an excimer laser, or the like, requires longer time for lithography (exposure) for a larger number of patterns to be subjected to the lithography with an electron beam. Therefore, with an increase in the recording density, time required for fine pattern formation increases, resulting in a remarkable decline in a manufacturing throughput. On the other hand, advanced for the purpose of speedup of pattern formation with the electron beam lithography device is development of a collective graphic irradiation method by which masks of a various kinds of shapes are combined together and then collectively subjected to irradiation of an electron beam. However, the electron beam lithography device using the collective graphic irradiation method is upsized and further requires a mechanism of controlling a mask position with even higher accuracy, which leads to an increase in costs of the lithography device itself, consequently raising, for example, a problem that a medium manufacturing cost increases.

In place of an exposure technology like the conventional one, suggested as the processing technology for a fine structure having the wavelength of light or less is a method based on a print technology. For example, Patent Document 1 (US005772905A) describes an invention related to “nanoimprint lithography (NIL) technology”. The nanoimprint lithography (NIL) technology is a technology by which by previously using a processing technology (for example, electron beam exposure technology) for a fine structure having the wavelength of light or less, a mold formed with a predetermined fine structure pattern is pressed against a transferred substrate to which resist has been applied while pressure is applied to thereby transfer the fine structure pattern of the mold onto a resist layer of the transferred substrate. As long as a mold is provided, any special exposure device is not required, and a duplicated object can be mass-produced with a device at a normal printer level, and thus compared to the electron beam exposure technology, etc., the throughput dramatically improves and the manufacturing costs are also dramatically reduced.

In the nanoimprint lithography (NIL) technology, as described in Patent Document 1 above, in a case where thermoplastic resin (for example, PMMA) is used as the resist, the temperature is increased up to a temperature near, equal to, or higher than a glass transfer temperature (Tg) of this material for the pressure application and the transfer. This method is called a thermal transfer method. The thermal transfer method has an advantage that general-purpose resin with thermoplastic properties can be used in a wide range. On the contrary, in a case where photosensitive resin is used as the resist, transfer is performed by photocurable resin that is cured by being exposed to light such as ultraviolet rays. This method is called a light transfer method.

The nanoimprint processing method employing the light transfer method requires the use of special photocurable resin, but compared to the thermal transfer method, has an advantage that a dimension error of a product completed through thermal expansion of a transfer print board or a printed member can be reduced. Moreover, other advantages are: that equipment of a heating mechanism and accessory devices for temperature increase, temperature control, cooling, etc. are not required; and that for the entire nanoimprinting device, no design consideration for measures against thermal strain such as heat insulation needs to be given.

FIG. 18 shows one example of a nanoimprint device 100 using a light transfer method according to conventional art. A transferred body placing board 104 is disposed on an up side surface of a base 102. And a transferred body 108 to which resist 106 has been applied is disposed on an up side surface of the transferred body placing board 104. A light transmissive mold 110 is arranged in such a manner as to face the transferred body 108 to which the resist 106 has been applied. On a bottom surface of the mold 110, a fine pattern 112 is formed. The mold 110 is supported by a transparent body 114, which is held by up-down arms 116. Arranged above the transparent body 114 is a UV light source 118 held by the up-down arms 116.

In performing imprinting operation, the up-down arms 116 are moved down to press the fine pattern 112 of the mold 110 against the resist 106 of the transferred body 108, and in this state, UV light is irradiated from the UV light source to the resist 106 of the transferred body 108 through the transparent body 114 to cure the resist 106. After the UV curing operation ends, the up-down arms 116 are moved up to separate the mold 110 from the transferred body 108.

However, in the device shown in FIG. 18, when there is a flaw or stain on a front surface of the transparent body 114 supporting the mold 110, this portion becomes a portion with curing unevenness of the resist 106 on the transferred body 108, resulting in a fine pattern forming defect. The transparent body 114 is formed of, for example, glass, acryl resin, or the like. Cleaning the transparent body 114 or replacing it with a new one upon every imprinting operation can avoid occurrence of the fine pattern forming defect but this results in a decrease in efficiency of transfer operation and high costs, providing an unpractical solution.

### SUMMARY OF THE INVENTION

Therefore, it is an object of the present invention to provide an optical imprinting method that hardly causes a fine pattern forming defect in optical imprinting operation.

It is another object of the invention to provide an optical imprinting device used for carrying out the optical imprinting method.

The first problem is solved by an optical imprinting method including the steps of: moving down a mold pressing mechanism detachably holding a mold formed with a fine pattern, and pressing the fine pattern of the mold onto resist applied to a transferred body placed on an up side surface of a transferred body placing board; after pressing the mold against the transferred body to firmly attach the mold to the transferred body, detaching the mold from the mold pressing mechanism; after detaching the mold, moving up the mold pressing mechanism from an up side surface of a laminated body of the mold and the transferred body; after moving up the mold pressing mechanism, arranging a UV light source above the up side surface of the laminated body of the mold and the transferred body and irradiating UV light to cure the resist; after completing the resist curing, relatively retracting the laminated body of the mold and the transferred body from the UV light source; and after relatively retracting the laminated body of the mold and the transferred body, moving down the mold pressing mechanism to hold the laminated body of the mold and the transferred body again, and then moving up the mold pressing mechanism to separate the mold from the transferred body

The second problem is solved by an optical imprinting device including at least: a transferred body placing board for placing a transferred body to which resist has been applied; a mold pressing mechanism which is capable of moving up and down, which faces the transferred body placing board, and which detachably holds a mold formed with a fine pattern; and a UV light source being arranged above an up side surface of the mold when the mold is detached from the mold pressing mechanism and firmly attached to an up side surface of the transferred body to which the resist has been applied and which is placed on an up side surface of the transferred body placing board.

In a conventional fine structure transfer device (optical imprinting device), UV light is irradiated to a transferred body through a light transmissive body while pressing a mold against the transferred body to thereby cure a resist layer. On the contrary, with the optical imprinting method and device of the invention, after the mold is pressed against the transferred body to firmly attach the mold to the transferred body, the mold pressing mechanism which has held the mold is moved up to separate the laminated body of the mold and the transferred body from the mold pressing mechanism. This makes it possible to arrange the UV light source directly on the up side surface of the mold, which permits direct UV irradiation to the mold. This can avoid occurrence of a forming defect or exposure unevenness attributable to a flaw or stain on a front surface of a light transmissive body, which used to conventionally occur upon UV light irradiation via the light transmissive body. In the case of the arrangement of the UV light source directly on the up side surface of the mold, possible are: both a mode in which the UV light source moves to a top side of the laminated body of the mold and the transferred body and a mode in which the laminated body of the mold and the transferred body moves to a bottom side of the UV light source. Therefore, “the step of retracting the laminated body of the mold and the transferred body from the UV light source after the completion of the resist curing” in the optical imprinting method of the invention is used in terms including both a mode in which the UV light source retracts from a side of the laminated body of the mold and the transferred body and a mode in which the laminated body of the mold and the transferred body retracts from a UV light source side.

### BRIEF DESCRIPTION OF THE DRAWINGS

FIG. 1 is a schematic configuration diagram of one example of an optical imprinting device used for carrying out an optical imprinting method of the present invention;

FIG. 2 is an explanatory diagram showing one process of the optical imprinting method of the invention carried out by the optical imprinting device shown in FIG. 1;

FIG. 3 is an explanatory diagram showing one process of the optical imprinting method of the invention carried out by the optical imprinting device shown in FIG. 1;

FIG. 4 is an explanatory diagram showing one process of the optical imprinting method of the invention carried out by the optical imprinting device shown in FIG. 1;

FIG. 5 is an explanatory diagram showing one process of the optical imprinting method of the invention carried out by the optical imprinting device shown in FIG. 1;

FIG. 6 is an explanatory diagram showing one process of the optical imprinting method of the invention carried out by the optical imprinting device shown in FIG. 1;

FIG. 7 is an explanatory diagram showing one process of the optical imprinting method of the invention carried out by the optical imprinting device shown in FIG. 1;

FIG. 8 is a schematic configuration diagram of another embodiment of the optical imprinting device used for carrying out the optical imprinting method of the invention;

FIG. 9 is a schematic configuration diagram of still another embodiment of the optical imprinting device used for carrying out the optical imprinting method of the invention;

FIG. 10 is an explanatory diagram showing one process of the optical imprinting method carried out by the optical imprinting device shown in FIG. 9;

FIG. 11 is an explanatory diagram showing one process of the optical imprinting method carried out by the optical imprinting device shown in FIG. 9;

FIG. 12 is an explanatory diagram showing one process of the optical imprinting method carried out by the optical imprinting device shown in FIG. 9;

FIG. 13 is an explanatory diagram showing one process of the optical imprinting method carried out by the optical imprinting device shown in FIG. 9;

FIG. 14 is an explanatory diagram showing one process of the optical imprinting method carried out by the optical imprinting device shown in FIG. 9;

FIG. 15 is a schematic configuration diagram of still another embodiment of the optical imprinting device used for carrying out the optical imprinting method of the invention;

FIG. 16 is a plan view taken along line A-A of FIG. 15;

FIG. 17A and FIG. 17B are photomaps showing test results related to presence and absence of exposure unevenness caused by an optical imprinting device of conventional art shown in FIG. 18.

FIG. 170 is a diagram showing results of an exposure test performed with the optical imprinting device of the invention shown in FIG. 1.

FIG. 18 is a schematic diagram of one example of the optical imprinting device of the conventional art.

### DESCRIPTION OF THE PREFERRED EMBODIMENTS

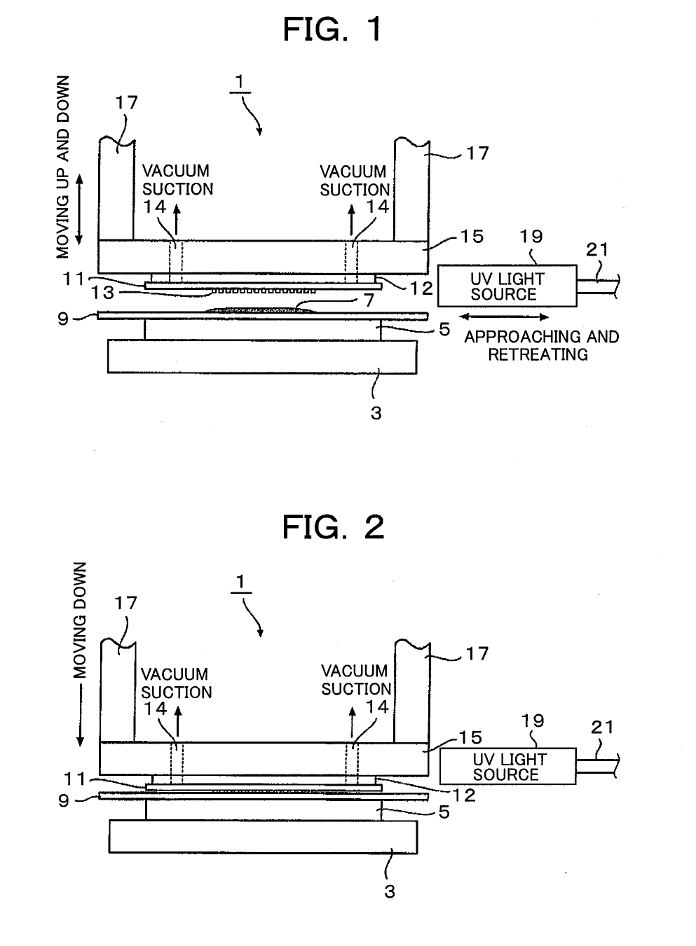

Hereinafter, the preferred embodiments of an optical imprinting method of the present invention will be described with reference to the accompanying drawings. FIG. 1 is a schematic configuration diagram of one example of an optical imprinting device 1 used for carrying out the optical imprinting method of the invention. In this device, a transferred body placing board 5 is disposed on an up side surface of a base 3, and a transferred body 9 to which resist 7 has been applied is placed on an up side surface of the transferred body placing board 5. A mold 11 of a light transmissive type is arranged in such a manner as to face the transferred body 9 to which the resist 7 has been applied. On a bottom surface of the mold 11, a fine pattern 13 is formed. The mold 11 is vacuum-suctioned by a vacuum chuck 12 disposed on a bottom side of a load transmitting member 15. The vacuum chuck 12 and the load transmitting member 15 are provided with suction holes 14, to one end of which an appropriate exhaust means (for example, a vacuum pump) (not shown) is connected. The load transmitting member 15 is firmly attached to up-and-down arms 17. A UV light source 19 is arranged at a position slightly higher than the transferred body 9 placed on the up side surface of the transferred body placing board 5 and at a section not crossing the falling load transmitting member 15. This UV light source 19 is held by an advancing and retracting arm 21 that moves linearly, and thus can linearly advance and retract in a horizontal direction.

Upon carrying out the optical imprinting method of the invention, the placement of the transferred body 9, to which the resist 7 has been applied, onto the up side surface of the transferred body placing board 5 of the device shown in FIG. 1 can be carried out by, for example, a regular automatic handling mechanism. The application of the resist 7 to the transferred body 9 is performed by, for example, spin coating, spray application, or an ink-jet method.

Refer to FIG. 2. FIG. 2 is an explanatory diagram showing one process of the optical imprinting method of the invention. When the transferred body 9 to which the resist 7 has been applied is placed onto the up side surface of the transferred body placing board 5, the up-and-down arms 17 start to move down and press the fine pattern 13 of the mold 11 against the resist layer 7 of the transferred body 9. At this point, the mold 11 is vacuum-chucked to a bottom surface of the load transmitting member 15 through vacuum suction. After application of predetermined pressure for a predetermined period of time, the vacuum suction is stopped to release the vacuum chucking of the mold 11.

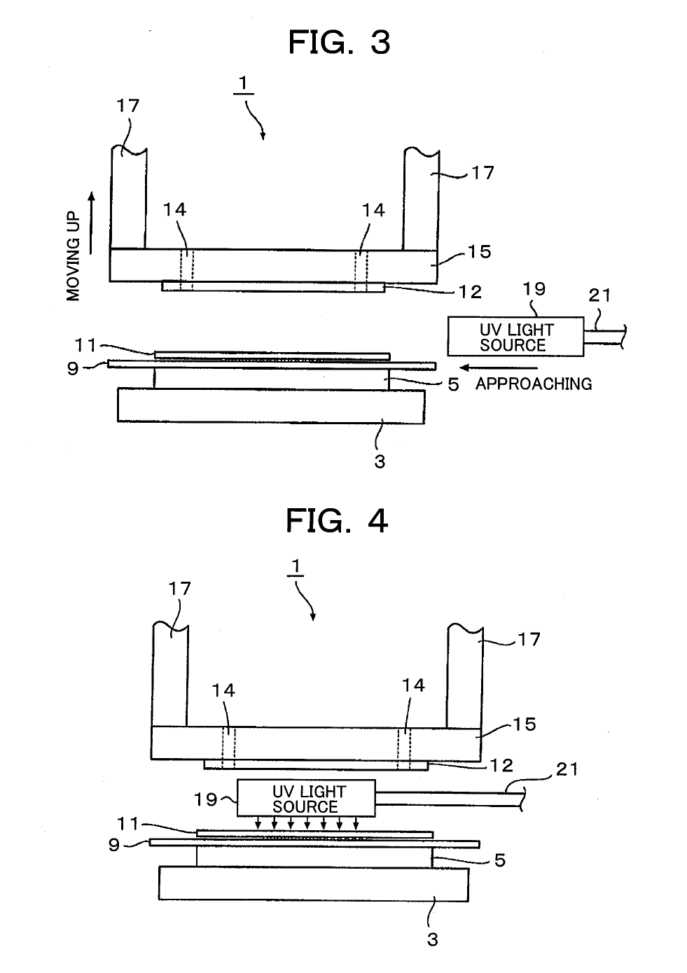

FIG. 3 is an explanatory diagram showing one process of the optical imprinting method of the invention. When the vacuum suction of the mold 11 has been released in the process of FIG. 2, the up-and-down arms 17 are moved up to separate the load transmitting member 15 from the mold 11 up to a necessary and sufficient height. Then the UV light source 19 is put by the advancing and retracting arm 21 into a space formed between the load transmitting member 15 and the mold 11.

FIG. 4 is an explanatory diagram showing one process of the optical imprinting method of the invention. After the UV light source 19 is put by the advancing and retracting arm 21 into the space formed between the load transmitting member 15 and the mold 11 in the process shown in FIG. 3, UV light is irradiated from the UV light source 19 to an up side surface of the mold 11 for a predetermined period of time. The mold 11 is formed of a light transmissive material (for example, glass or transparent acryl resin), and thus the UV light is transmitted through the mold 11 to photo-cure the resist layer lying at an interface between the mold 11 and the transferred body 9. The UV light source 19 can be brought into contact with the up side surface of the mold 11, but to make it easy to arrange the UV light source 19, it is preferable that the UV light source 19 be located away from the mold 11 with a slight gap therebetween without making contact with the up side surface of the mold 11.

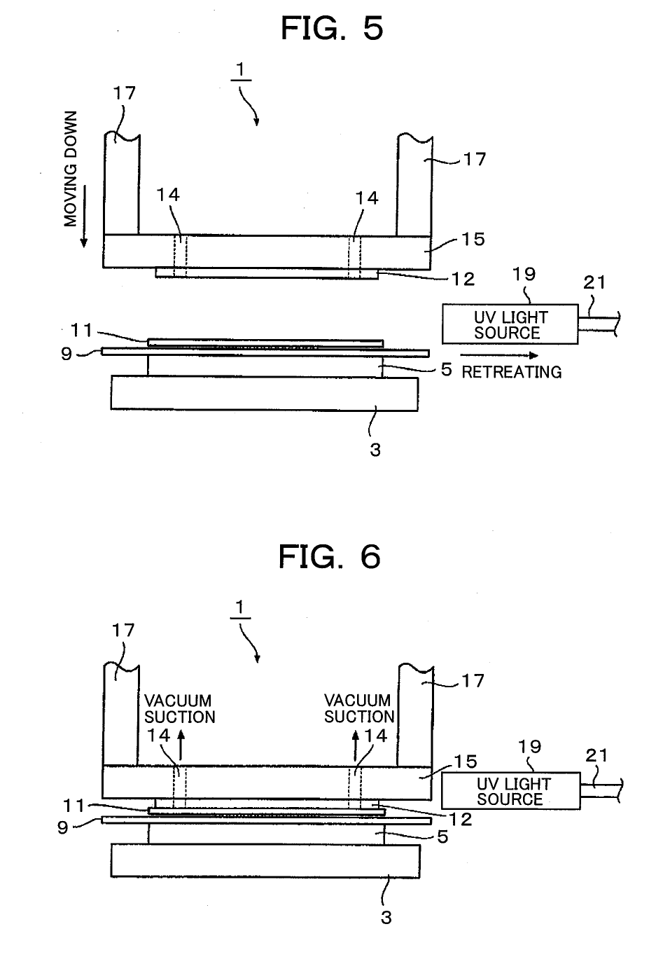

FIG. 5 is an explanatory diagram showing one process of the optical imprinting method of the invention. After the photo-curing operation is completed, the UV light source 19 is retracted by the advancing and retracting arm 21. Then the up-and-down arms 17 are moved down.

FIG. 6 is an explanatory diagram showing one process of the optical imprinting method of the invention. After the up-and-down arms 17 are moved down to firmly attach the vacuum chuck 12 below the load transmitting member 15 to the up side surface of the mold 11, vacuum suction is started.

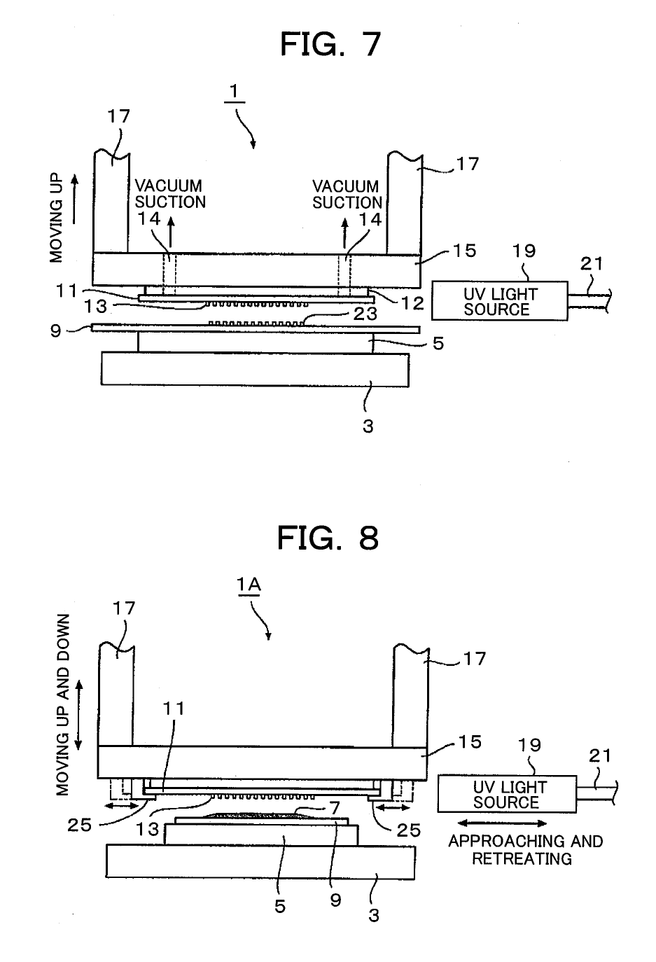

FIG. 7 is an explanatory diagram showing one process of the optical imprinting method of the invention. After the mold 11 is vacuum-suctioned by the vacuum chuck 12 located on the bottom side of the load transmission member 15, the up-and-down arms 17 start to move up to separate the mold 11 from the transferred body 9. After a while, a pattern layer 23 having an inverted form of the fine pattern 13 of the mold 11 is formed onto the up side surface of the transferred body 9. Although not shown, the optical imprinting device 1 shown in FIG. 1 can also be provided with an automatic handling mechanism for loading/unloading the transferred body 9 onto/from the up side surface of the transferred body placing board 5. Therefore, after the imprinting operation is completed, the transferred body 9 which has already been transferred can be unloaded from the up side surface of the transferred body placing board 5 by the automatic handling mechanism, then a new transferred body 9 to which a resist layer 7 has been applied can be loaded onto the up side surface of the transferred body placing board 5 by the automatic handling mechanism, and the optical imprinting operation of FIGS. 2 to 7 can be continued.

FIG. 8 is a schematic configuration diagram of another embodiment of the optical imprinting device used for carrying out the optical imprinting method of the invention. In the device 1 shown in FIG. 1, the mold 11 is detachably held on the bottom side of the load transmitting member 15 by the vacuum chuck 12, but the device 1A of FIG. 8 adopts configuration such that a mold 11 is detachably held on a bottom side of a load transmitting member 15 by a clamping mechanism 25. In a case where a size of a transferred body 9 is smaller than a size of the mold 11, the clamping mechanism 25 can be adopted. The clamping mechanism 25, as shown in the figure, is configured to be movable inwardly or outwardly on an outer circumference of the mold 11. However, it is needless to say that a clamping mechanism of a type different from that shown in the figure can also be used.

To carry out the optical imprinting method of the invention with the device 1A of FIG. 8, after the transferred body 9 to which resist 7 has been applied is placed on an up side surface of a transferred body loading board 5, the load transmitting member 15 moves down and the mold 11 held on the bottom side of the load transmitting member 15 by the clamping mechanism 25 is pressed against the resist 7 of the transferred body 9. Then the clamping mechanism 25 escapes to the outside to detach the mold 11. The detachment of the mold 11 moves up up-and-down arms 17 to separate the load transmitting member 15 from the mold 11 up to a necessary and sufficient height. Then a UV light source 19 is moved by an advancing and retracting arm 21 into a space formed between the load transmitting member 15 and the mold 11. After the UV exposure operation is completed, the UV light source 19 is retracted by the advancing and retracting arm 21. Then the up-and-down arms 17 are moved down and the clamping mechanism 25 on the bottom side of the load transmitting member 15 is moved to inside to thereby hold with the clamping mechanism 25 the mold 11 firmly attached to the transferred body 9. Under a state in which the mold 11 is held by the clamping mechanism 25, the up-and-down arms 17 are moved up. After a while, the transferred body 9 onto which a pattern opposite to the fine pattern 13 of a mold 25 has been transferred is obtained.

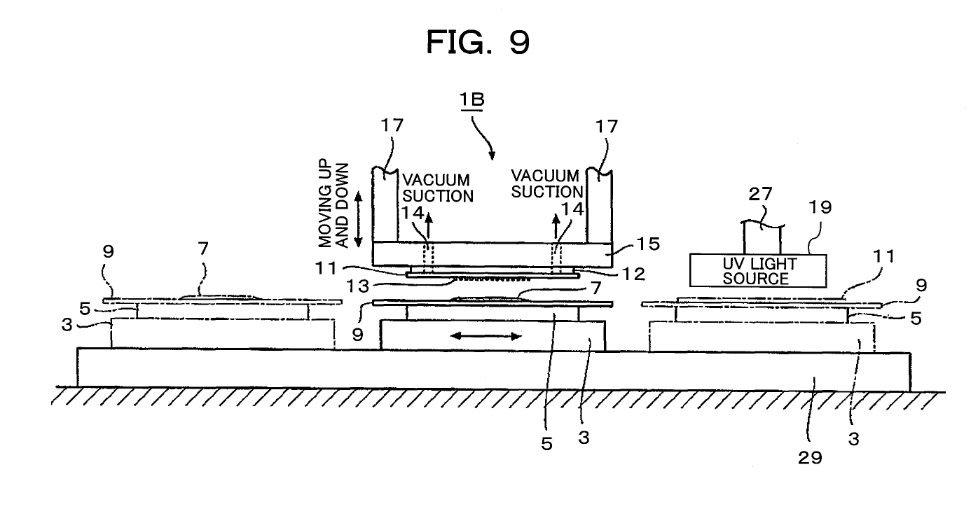

FIG. 9 is a schematic configuration diagram of still another embodiment of the optical imprinting device used for carrying out the optical imprinting method of the invention. In the device 1B of FIG. 9, a base 3 having a transferred body placing board 5 is so configured to be movable to the left and right on a guide rail 29, and a UV light source 19 is held at a fixed position by a support arm 27. The base 3 can be moved on the guide rail 29 by using a well-known means such as a linear motor, a stepping motor, or a ball screw.

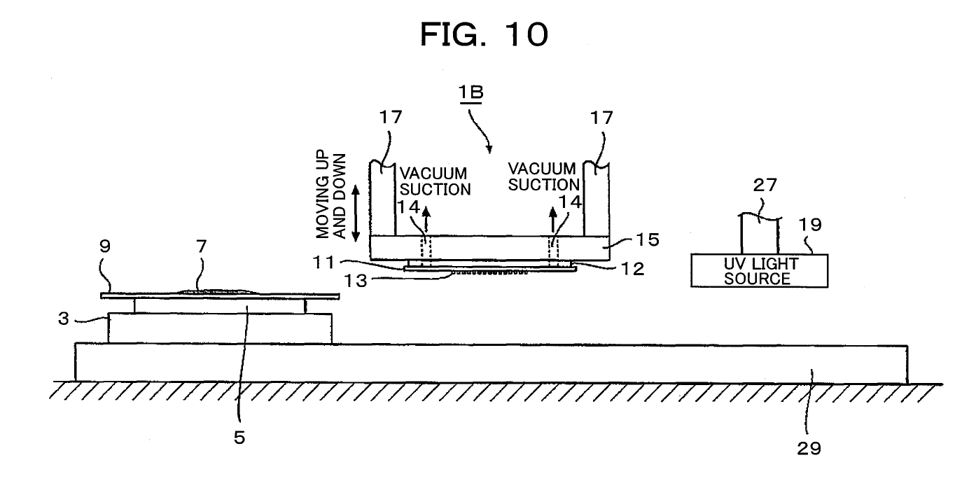

As shown in FIG. 10, the base 3 having the transferred body placing board 5 is moved along the guide rail 29 to a position at a left end. At this position, a transferred body 9 to which resist 7 has been applied is placed on an up side surface of the transferred body placing board 5 by an automatic handling mechanism (not shown). As another method, as shown in FIG. 9, if the transferred body 9 to which the resist has been applied can be loaded on the up side surface of the transferred body loading board 5 by the automatic handling mechanism (not shown) immediately below a load transmitting member 15 which vacuum-chucks a mold 11, the base 3 having the transferred body placing board 5 does not have to be moved to the left end of the guide rail 29.

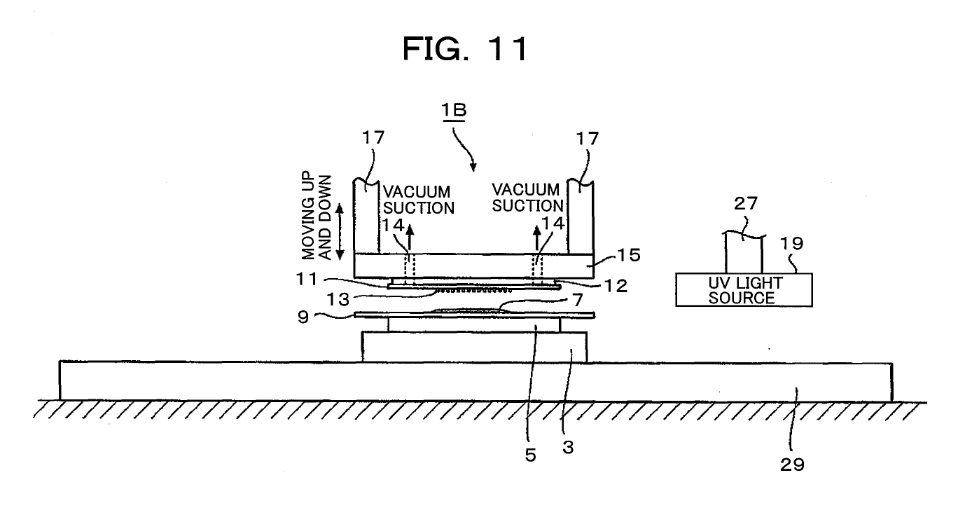

After the transferred body 9 is placed onto the up side surface of the transferred body placing board 5, as shown in FIG. 11, the base 3 is moved along the guide rail 29 to a position immediately below the mold 11. Formed on a bottom surface of the mold 11 is a fine pattern 13. As is the case with the device 1 shown in FIG. 1, the mold 11 is vacuum-suctioned by a vacuum chuck 12 disposed on a bottom side of the load transmitting member 15. The vacuum chuck 12 and the load transmitting member 15 are provided with suction holes 14, to one end of which an appropriate exhaust means (for example, vacuum pump) (not shown) is connected. The load transmitting member 15 is firmly attached to up-and-down arms 17. After positioning of the mold 11 and the transferred body 9 is completed, the up-and-down arms 17 start to move down to press the fine pattern 13 of the mold 11 against the resist layer 7 of the transferred body 9. At this point, the mold 11 is vacuum-chucked to a bottom surface of the load transmitting member 15 through vacuum suction. After application of predetermined pressure for a predetermined period of time, the vacuum suction is stopped to release the vacuum chucking of the mold 11. This brings about a state in which the mold 11 is firmly attached to an up side surface of the transferred body 9, and thus moving up the up-and-down arms 17 permits the mold 11 to detach from the bottom side of the load transmitting member 15.

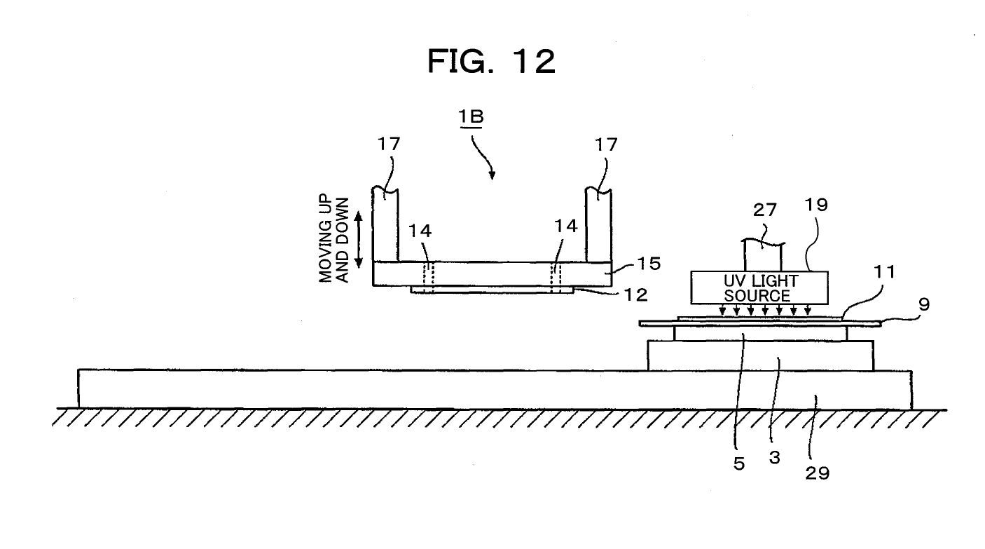

Then as shown in FIG. 12, the base 3 is moved along the guide rail 29 to a position immediately below the UV light source 19. On the up side surface of the transferred body placing board 5 on the base 3, a laminated body formed by firmly attaching the mold 11 to the up side surface of the transferred body 9 lies. As described above, the mold 11 is formed of a light transmissive material, and thus the UV light from the UV light source 19 is transmitted through the mold 11 to cure the resist applied to the transferred body 9.

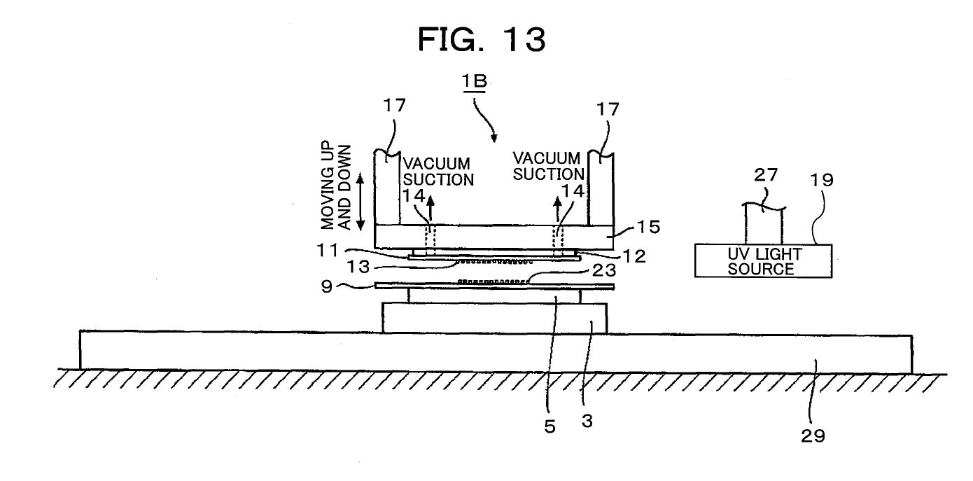

After the resist curing processing is completed, the base 3 is moved along the guide rail 29 to a position immediately below the load transmitting member 15. After the movement, the up-and-down arms 17 are moved down to firmly attach the vacuum chuck 12 to an up side surface of the mold 11 for vacuum suction. While the mold 11 is subjected to the vacuum suction by the vacuum chuck 12, the up-and-down arms 17 are moved up to separate the mold 11 from the up side surface of the transferred body 9. After a while, as shown in FIG. 13, the transferred body 9 to which the pattern 23 opposite to the fine pattern 13 of the mold 11 has been transferred is obtained.

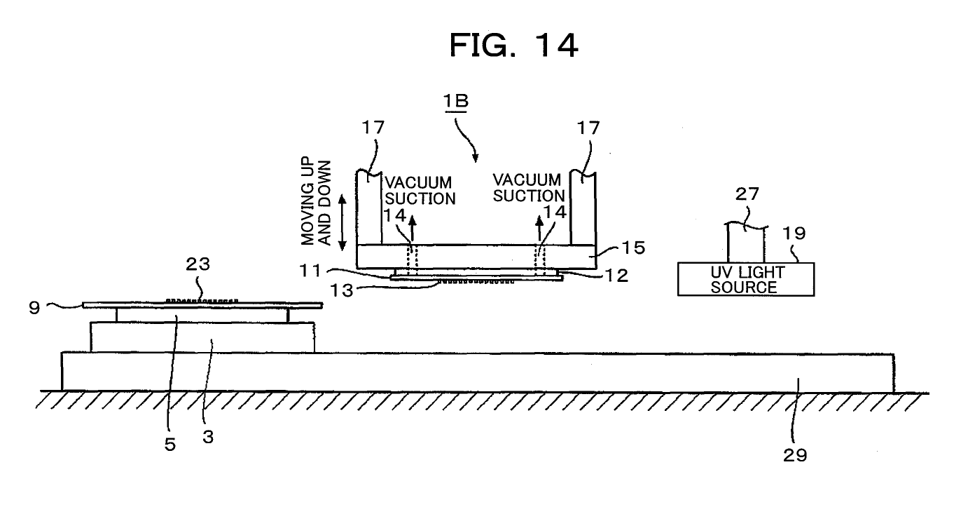

As shown in FIG. 14, the base 3 is moved along the guide rail 29 to a left end position. At this position, the transferred body 9 to which the pattern 23 opposite to the fine pattern 13 of the mold 25 has been transferred is unloaded from the up side surface of the transferred body placing board 5 by the automatic handling mechanism (not shown), and then as shown in FIG. 10, the transferred body 9 to which the resist 7 has been applied is loaded to the up side surface of the transferred body placing board 5, and then the processing operation of FIGS. 11 to 14 is repeated. As described above, if the transferred body 9 with the inverted pattern can be unloaded by the automatic handling mechanism (not shown) immediately below the load transmitting member 15 that vacuum-chucks the mold 11, the base 3 having the transferred body placing board 5 does not have to be moved to the left end of the guide rail 29.

In the optical imprinting device 1B shown in FIG. 9, as is the case with the device 1 shown in FIG. 1, the mold 11 is held by the vacuum chuck 12, but as is the case with the device 1A shown in FIG. 8, a mode in which the mold 11 is held by the clamping mechanism 25 can be adopted.

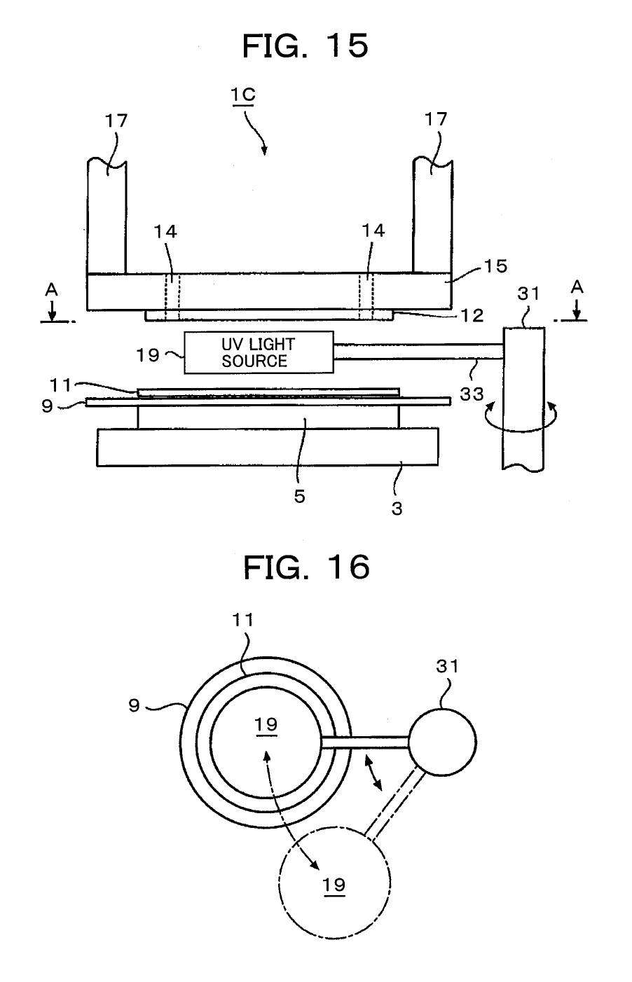

In the optical imprinting device 1 shown in FIG. 1, the UV light source 19 is held by the linearly moving advancing and retracting arm 21, and linearly advances and retracts in the horizontal direction, although the invention is not limited to this embodiment. For example, in a device 1C shown in FIG. 15, a possible embodiment is fixing a UV light source 19 to an end part of a support arm 33 fitted to a rotating shaft 31. As shown in FIG. 16, as a result of the rotation of the shaft 31, the UV light source 19 is also pivoted in a horizontal direction. Consequently, at time of exposure, the UV light source 19 can be arranged above an up side surface of a mold 11 firmly attached to an up side surface of a transferred body 9, and the UV light source 19 can be retreated to a position indicated by a virtual line before and after the exposure.

As the UV light source 19, any of all UV light sources well-known to those skilled in the art can be used. Examples of such UV light sources include: a high-pressure mercury lamp, a medium-pressure mercury lamp, a low-pressure mercury lamp, a mercury xenon lamp, a halogen lamp, a metal halide lamp, and a UV-LED lamp.

In the optical imprinting device of the invention, for example, an X-Y stage required for performing positioning of the mold 11 and the transferred body 9 can be included, if desired. Such an X-Y stage is well-known to those skilled in the art.

### First Example

Testing is performed on presence and absence of exposure unevenness in the optical imprinting device of the invention shown in FIG. 1 and in an optical imprinting device of conventional art shown in FIG. 18.

In the optical imprinting device 1 of the invention, used as the mold 11 is light transmissive optical glass (with a thickness of 0.7 mm) on a bottom side of which a fine pattern with a pitch of 70 nm is formed. Used as the transferred body 9 is a silicon substrate with a thickness of 0.635 mm. Used as the resist material 7 is an acrylic photopolymerization material, which is spin-coated on the up side surface of the transferred body 9 to a thickness of 40 nm. Used as the UV light source 19 is a UV-LED lamp.

In the optical imprinting device 100 of the conventional art, the same mold, transferred body, resist material, and UV light source as those of the optical imprinting device 1 of the invention are used. However, UV light from a UV light source 118 is transmitted through the mold via a quart transparent body 114 having a thickness of 15 mm. A small flaw is previously formed on a front surface of the quart transparent body 114.

In order to verify that the same mold is used in the both devices, a defect portion is artificially provided at part of the mold.

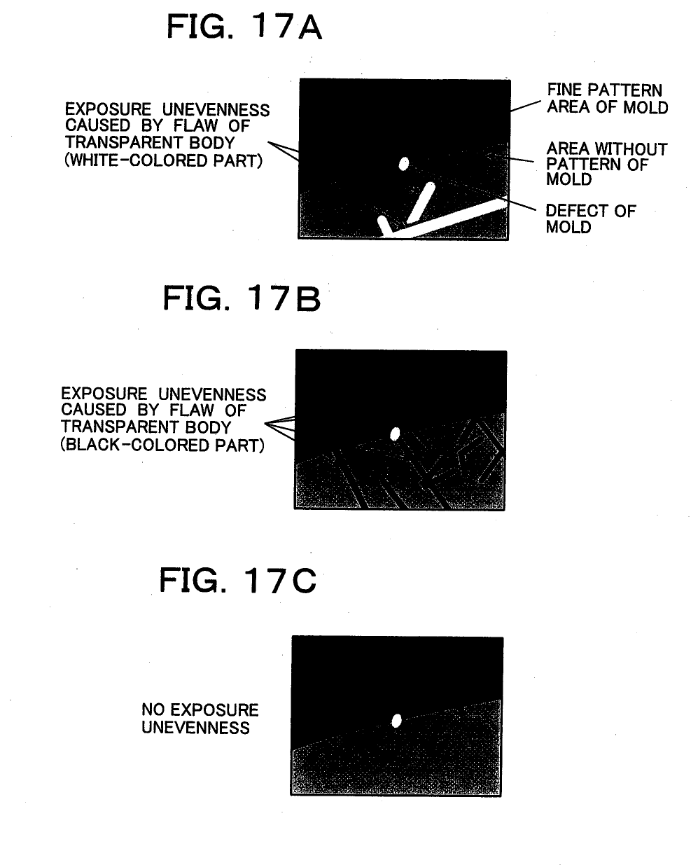

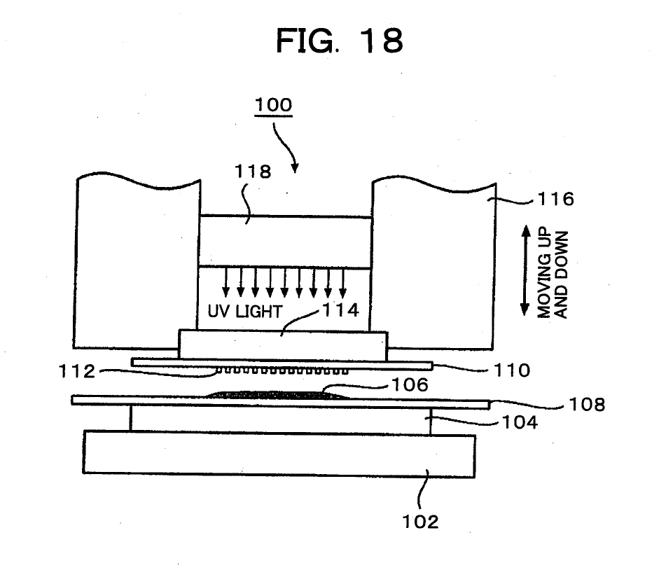

FIG. 17 show results of imprinting. FIGS. 17A and 17B show the results of the imprinting by the optical imprinting device 100 of the conventional art, with photos taken by observing transferred patterns on the up side surface of the transferred body with a magnification of 5×. In FIG. 17A, the defect part of the mold is transferred, and also in an area without the pattern of the mold, exposure unevenness caused by the flaw of the transparent body 114 is present as a white-colored part. Moreover, in FIG. 17B, the defect part of the mold is transferred onto the same position, and in both areas with and without the pattern of the mold, exposure unevenness caused by a flaw different from that of FIG. 17A is present as a black-colored part.

On the contrary, in the optical imprinting device of the invention in which exposure is performed directly from the up side surface of the mold with the UV light source, exposure unevenness is never present in either of the areas with and without the pattern of the mold.

What can be understood based on these results is superiority of the optical imprinting device and the optical imprinting method according to the invention that perform the exposure directly from the up side surface of the mold with the UV light source.

The preferred embodiments of the optical imprinting method of the invention have been described in detail above, but the invention is not limited to the embodiments disclosed. For example, during the optical imprinting operation, the transferred body 9 can be vacuum-chucked to the transferred body placing board 5.

What is claimed is:

1. An optical imprinting method comprising the steps of:
moving down a mold pressing mechanism detachably holding a mold formed with a fine pattern, and pressing the fine pattern of the mold onto resist applied to a transferred body placed on an up side surface of a transferred body placing board;
after pressing the mold against the transferred body to firmly attach the mold to the transferred body, detaching the mold from the mold pressing mechanism;
after detaching the mold, moving up the mold pressing mechanism from an up side surface of a laminated body of the mold and the transferred body;
after moving up the mold pressing mechanism, arranging a UV light source above the up side surface of the laminated body of the mold and the transferred body and irradiating UV light to cure the resist;
after completing the resist curing, relatively retracting the laminated body of the mold and the transferred body from the UV light source; and
after relatively retracting the laminated body of the mold and the transferred body, moving down the mold pressing mechanism to hold the laminated body of the mold and the transferred body again, and then moving up the mold pressing mechanism to separate the mold from the transferred body.

2. An optical imprinting device comprising at least:
a transferred body placing board for placing a transferred body to which resist has been applied;
a mold pressing mechanism being capable of moving up and down, the mold pressing mechanism facing the transferred body placing board and detachably holding a mold formed with a fine pattern; and
a UV light source being arranged above an up side surface of the mold when the mold is detached from the mold pressing mechanism and firmly attached to an up side surface of the transferred body to which the resist has been applied and which is placed on an up side surface of the transferred body placing board.

3. The optical imprinting device according to claim 2,
wherein
the mold is detachably held by the mold pressing mechanism by a vacuum chuck mechanism.

4. The optical imprinting device according to claim 2,
wherein
the mold is detachably held by the mold pressing mechanism by a clamp mechanism.

5. The optical imprinting device according to claim 2,
wherein
the transferred body placing board is fixed to a base being movable along a guide rail in a horizontal direction,
the UV light source is fixed at a position adjacent to the mold pressing mechanism being capable of moving up and down, and
the transferred body placing board fixed to the base moves along the guide rail in the horizontal direction between the mold pressing mechanism being capable of moving up and down and the UV light source.

6. The optical imprinting device according to claim 3,
wherein
the transferred body placing board is fixed to a base being movable along a guide rail in a horizontal direction,
the UV light source is fixed at a position adjacent to the mold pressing mechanism being capable of moving up and down, and
the transferred body placing board fixed to the base moves along the guide rail in the horizontal direction between the mold pressing mechanism being capable of moving up and down and the UV light source.

7. The optical imprinting device according to claim 4,
wherein
the transferred body placing board is fixed to a base being movable along a guide rail in a horizontal direction,
the UV light source is fixed at a position adjacent to the mold pressing mechanism being capable of moving up and down, and
the transferred body placing board fixed to the base moves along the guide rail in the horizontal direction between the mold pressing mechanism being capable of moving up and down and the UV light source.

8. The optical imprinting device according to claim 2,
wherein
the UV light source is held by an advancing and retracting mechanism making linear movement, and linearly advances and retracts in a horizontal direction to be_arranged above an up side surface of the mold.

9. The optical imprinting device according to claim 3,
wherein
the UV light source is held by an advancing and retracting mechanism making linear movement, and linearly advances and retracts in a horizontal direction to be_arranged above an up side surface of the mold.

10. The optical imprinting device according to claim 4,
wherein
the UV light source is held by an advancing and retracting mechanism making linear movement, and linearly advances and retracts in a horizontal direction to be_arranged above an up side surface of the mold.

11. The optical imprinting device according to claim 2,
wherein
the UV light source is fixed to an end part of a support arm fitted to a rotary shaft, and is arranged above an up side surface of the mold by horizontal rotation of the rotary shaft.

12. The optical imprinting device according to claim 3,
wherein
the UV light source is fixed to an end part of a support arm fitted to a rotary shaft, and is arranged above an up side surface of the mold by horizontal rotation of the rotary shaft.

13. The optical imprinting device according to claim 4,
wherein
the UV light source is fixed to an end part of a support arm fitted to a rotary shaft, and is arranged above an up side surface of the mold by horizontal rotation of the rotary shaft.
